(19) United States
(12) Patent Application Publication
(10) Pub. No.: US 2022/0277395 A1
(43) Pub. Date: Sep. 1, 2022

(54) VIRTUAL INTRODUCTION SYSTEMS AND METHODS

(71) Applicant: THE KROWD, INC., Chicago, IL (US)

(72) Inventors: Noor SUGRUE, Chicago, IL (US); Gary YI, Chicago, IL (US); Maximillian SUGRUE, Chicago, IL (US)

(73) Assignee: THE KROWD, INC., Chicago, IL (US)

(21) Appl. No.: 17/679,884

(22) Filed: Feb. 24, 2022

Related U.S. Application Data
(60) Provisional application No. 63/154,608, filed on Feb. 26, 2021.

(51) Int. Cl. G06Q 40/06; H04N 7/14

(52) U.S. Cl. CPC G06Q 40/06; H04N 7/147; G06N 20/00

(57) ABSTRACT

The systems and methods described herein establish one or more communication connections between one or more expert user devices and one or more entrepreneur user devices via a network connection. The system may generate a likelihood of success score between the expert user and the entrepreneur user based on characteristics of the expert user, a product or service of the entrepreneur user, or other parameters associated with the entrepreneur user and the expert user. If the likelihood of success score exceeds a threshold value, the system may generate a timeslot reservation between the entrepreneur user and the expert user.

### CROSS REFERENCE TO RELATED APPLICATIONS

This application claims priority to U.S. Patent Application No. 63/154,608, filed on Feb. 26, 2021, the contents of which are incorporated herein by reference in its entirety.

### TECHNICAL FIELD

The disclosed technology relates generally to providing a computer system to establish connections and initiate communications between users. More particularly, various embodiments relate to systems and methods for applying a matching algorithm and trained machine learning models to identify and form communication connections between user devices.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is an illustrative connection and communication system, in accordance with the embodiments disclosed herein.

FIG. 2 is an illustrative process for an entrepreneur user device, in accordance with the embodiments disclosed herein.

FIG. 3 is an illustrative search user interface, in accordance with the embodiments disclosed herein.

FIG. 4 is an illustrative search user interface, in accordance with the embodiments disclosed herein.

FIG. 5 is an illustrative expert user profile, in accordance with the embodiments disclosed herein.

FIG. 6 is an illustrative communication and connection interface tool, in accordance with the embodiments disclosed herein.

FIG. 7 is an illustrative entrepreneur user device, in accordance with the embodiments disclosed herein.

FIG. 8 is an illustrative process for generating a virtual introduction, in accordance with the embodiments disclosed herein.

FIG. 9 is an additional illustrative process for generating a virtual introduction, in accordance with the embodiments disclosed herein.

FIG. 10 is an example of a computing system that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Conventional systems may rely on real-world connections between individuals to establish an electronic communication between corresponding user devices online. For example, in some conventional social networking environments, the individuals may be related to each other through a middleman that can show that the two users are related through the middleman and should be introduced online, forming a new connection between the two individuals in an online environment. In other conventional systems, the electronic connection between the users may rely on one user providing identifying information about a second user (e.g., email address or phone number) in order to establish an electronic connection between the corresponding user devices. However, users that want to electronically communicate with other users may not always have access to this information, so the electronic communication connection is never formed in these conventional systems.

Embodiments of the application solve this electronic communication problem by matching an entrepreneur user and an expert user and generating an electronic communication session for these users by a connection and communication system. Beyond general online networking, the system described herein can automatically generate a virtual introduction through various forms of media such that the entrepreneur user and expert user obtain a direct communication line. Furthermore, the system can take steps to optimize the potential communication session by matching the entrepreneur user and expert user using a machine learning model with various input criteria (e.g., through the entrepreneur user's investment goals, the expert user's monetary availability, or other characteristics) in order to maintain the communication connection for a period of time.

Technical improvements exist throughout the disclosure. For example, the system can automatically reserve a time slot for the entrepreneur user and the expert user for conducting the electronic communication session without relying on preexisting connections or identifiers (e.g., email, phone number, middleman user, etc.). The system can also automatically transmit an electronic file to establish a virtual introduction, initiate a video call, send various forms of media for either user to review, or establish other communication methods. The system can match the entrepreneur user and the expert user through an improved matching algorithm that avoids relying on pre-existing communication methods or connections to form the new electronic communication session where no connections may have prior existed.

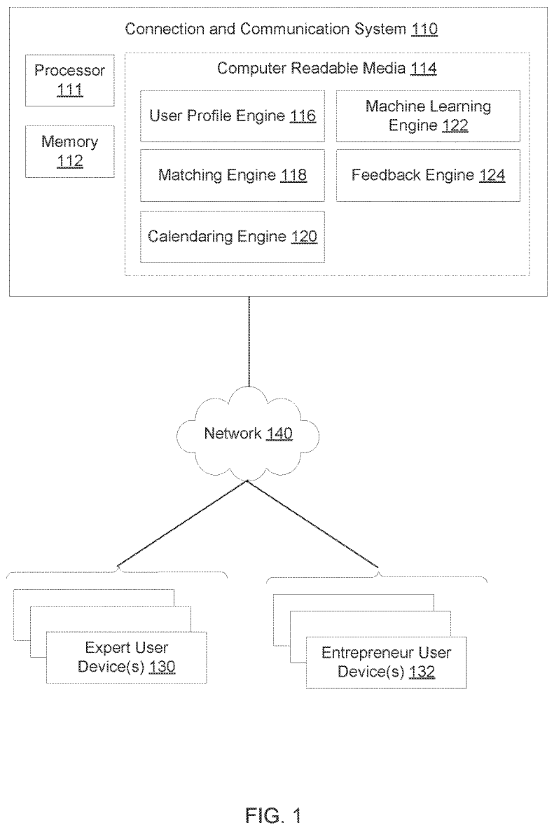

FIG. 1 is an illustrative connection and communication system, in accordance with the embodiments disclosed herein. The connection and communication system 110 may be in communication with one or more expert user devices 130 and one or more entrepreneur user devices 132 via network 140.

Connection and communication system 110 may comprise processor 111 (e.g., controllers, control engines, or other processing devices), memory 112, and computer readable media 114. Processor 111 might be implemented using a general-purpose or special-purpose processing engine such as, for example, a microprocessor, controller, or other control logic.

Connection and communication system 110 might also include one or more memory 112 and machine readable media 114. For example, memory 112 and/or machine readable media 114 may comprise random-access memory (“RAM”) or other dynamic memory, might be used for storing information and instructions to be executed by processor 111. Memory 112 and/or machine readable media 114 might also be used for storing temporary variables or other intermediate information during execution of instructions to be executed by processor 111. Memory 112 and/or machine readable media 114 might likewise include a read only memory (“ROM”) or other static storage device coupled to a bus for storing static information and instructions for processor 111.

Computer readable media 114 may comprise machine readable instructions operable through a plurality of modules or engines to enable functionality described throughout the disclosure. For example, computer readable media 114 may comprise user profile engine 116, matching engine 118, calendaring engine 120, machine learning engine 122, and feedback engine 124.

User profile engine 116 is configured to generate a user profile for an expert user. The expert user may be associated with a plurality of characteristics, including a name, profile image, job title, company, expertise, price per session, expertise description, and other relevant information. The expert user may access connection and communication system 110 via network 140 using expert user device 130 (e.g., mobile device, personal computer, etc.) to access a submitted pitch file from an entrepreneur user or may receive the pitch file from the entrepreneur user directly via network 140 at expert user device 130.

A pitch file may comprise an audio/visual (A/V) file that describes a product or service provided by the entrepreneur user. The pitch file may request feedback from the expert user for a particular aspect of the product or service. In some examples, the pitch file may be a data stream and the connection between the entrepreneur user and expert user may be a real-time connection via network 140.

User profile engine 116 is configured to generate a user profile for an entrepreneur user. The entrepreneur user may be associated with search criteria related to an entrepreneur user's product or service. The entrepreneur user may also be associated with a plurality of characteristics, including a name and entrepreneur user device 132 (e.g., mobile device, personal computer, etc.). Entrepreneur user device 132 may be configured to generate a pitch file or other similar recording that can be transmitted to expert user device 130.

In some examples, expert user device 130 may be configured to generate a feedback file or other similar recording that can be transmitted to a user device or software application of the entrepreneur user. The feedback file may be transmitted in response to receiving the pitch file associated with entrepreneur user device 132.

Matching engine 118 is configured to match an entrepreneur user with an expert user, for example, by matching the search criteria of the entrepreneur user with one or more characteristics of the expert user, or in some examples, by filtering expert users based on shared characteristics or likelihood of success score (determined by machine learning engine 122, described below).

In some examples, matching engine 118 may determine a subset of expert users based on a budget first allocation. For example, the entrepreneur user may provide a budget value and matching engine 118 may determine the subset of expert users that are most likely to provide feedback for the entrepreneur user (e.g., best bang for the buck) using an inferred likelihood of involvement between the expert user and entrepreneur user.

The budget first allocation may classify the plurality of expert users and entrepreneur users using one or more classification systems. The classification systems may include, for example, Global Industry Classification Standard (GICS), Industry Classification Benchmark, International Standard Industrial Classification, United Nations (UN) Sustainable Development Goals (SDGs), and the like. The expert users may select one or more of these classifications as an area of interest or expertise for related products or services. The entrepreneur users may also select one or more of these classifications, or the system may automatically identify the classification based on the metadata of the pitch file or the characteristics of the entrepreneur user.

The budget first allocation may also filter a subset of expert users from the plurality of expert users by matching the expert users' classifications with the classifications relating to the entrepreneur user. The filtering process may, in some examples, consider a geographic location of the expert user and entrepreneur user to restrict the subset of expert users that are provided to the entrepreneur user.

The budget first allocation may also determine an efficiency of each expert user with their time. The efficiency may be measured by the amount of feedback that the expert user has provided to other entrepreneur users in past interactions, an amount of funding that the expert user has provided to other entrepreneur users in response to pitch files (e.g., the entrepreneur user pays $1000 for 5 minutes of meeting time with the expert user, expert user funds $100,000 of the entrepreneur's company, etc.).

The budget first allocation may also attempt to maximize an entrepreneur user's reach to one or more expert users. For example, starting with the budget value invested by the entrepreneur user, matching engine 118 may select the expert user that is likely to provide the largest funding amount and also taking into account the matched characteristics between the expert user in the entrepreneur user.

In some examples, matching engine 118 is configured to determine a subset of expert users based on a matching algorithm. For example, let the resulting group of investors be the universe U. Each I∈U has properties rᵢ, sᵢ, a, c where:

r measures likelihood/ratio of investment activity

s measures frequency & quantity balance of chat responses

a is the mid-point of user's self-indicated investment amount/capability

c is the price to pitch to that investor->the cost to buyer

In some examples, matching engine 118 can devise a formula concerned about r & s such that matching engine 118 may determine a measure for “weight” or “activeness” of each investor.

The ratio a/c may be the “efficiency” measure for that investor. Matching engine 118 may assume that as cost increases (investor is more prominent), their investment capabilities grow even faster. Thus, matching engine 118 may determine that high profile investors are more “efficient.” Qualitatively, an investor with high “activeness” and high “efficiency” is a high “value” investor irrespective of their absolute cost or investment capability. Budget and objective (raising target) may be strongly intertwined. In fact, in the first quadrant of R² most of the region may not have resolutions.

When associating the matching algorithm with budget first allocation, the entrepreneur user may provide a budget B. Matching engine 118 may apply a “0-1 knapsack” problem/solution to determine the maximum total capability and multiply it by R_{I} to receive the maximum expected investment:

{(aᵢ,cᵢ)}:maximizeΣa_{chosen} such that Σc_{chosen}≤B

In some examples, matching engine 118 may determine a subset of expert users based on an objective first allocation problem. In these examples, no budget may be provided from entrepreneur user and the value that will be maximized may be associated with the reach and/or funding provided by the determined expert user for the entrepreneur user. In this example, matching engine 118 may maximize the expert user's expertise in a particular classification (e.g., clothing industry, green technology, etc.) to provide the most value to the entrepreneur user. Other factors may be maximized, including the activeness of expert user, the likelihood that the expert user will provide funding to the entrepreneur user, the reliability of the expert user to provide feedback, and the like.

In an illustrative example, the entrepreneur user may want to raise $1 million associated with the product or service. Matching engine 118 may adjust a confidence value of the expert users to determine the expert users that may provide the highest amount of funding (e.g., more aggressive recommendation). The confidence value may be adjusted from 3% to 5% to help ensure that the pitch file is transmitted to expert users with a higher confidence of responding favorably to the entrepreneur user's pitch file. In another example, the entrepreneur user may want to raise $100 million with an expected likelihood of success of only 1%. If only 1% would engage, matching engine 118 may select the most efficient subset of expert users in order to aggregate the amount of funding from expert users that the entrepreneur user wants to raise.

The confidence value of the expert user may be adjusted based on feedback from the entrepreneur user. For example, a first entrepreneur user may post feedback to a social media network (e.g., give a shout out, etc.) to identify that the expert user has provided good feedback to the first entrepreneur user. The confidence value of the expert user may be increased based on the feedback from the first entrepreneur user. The higher confidence value of the expert user may be considered when a second entrepreneur user is considered for the same expert user in the objective first allocation problem. As more data comes in, matching engine 118 may determine a beta distribution of how likely that the expert user will take action for future entrepreneur users.

When associating the matching algorithm with objective first allocation problem, the entrepreneur user may identify raising target T. Matching engine 118 may use a greedy algorithm. For example, let R_{I}∈(0, 1) be the platform-wide investment ratio. In order to raise the full amount needed, the total capability in portfolio should be greater than T/R_{I}. Matching engine 118 may rank all elements of U based on “activeness” in descending order and add the most “active” person to list. If total investment capability doesn't pass the threshold, then move on to the next expert user.

Activeness may be defined by various metrics. For example, active does may be defined in terms of investments reported by expert users, total number of reviews, amount of feedback (e.g., length or time, etc.), and the like.

$${r}_{i} = ( no . investments reported by buyer ) / ( no . of total review requests )$$

$${s}_{i} = {\sum }_{l = 0}^{∞} {f}_{l} \cdot {l}^{x}$$

Where I is the length of a conversation as measured in pairs of exchanges in a session. A session may refer to the time between the expert user seeing the pitch file and the earliest of (1) current time (2) date receiving next (3) entrepreneur user acknowledging substantial involvement from expert user. n is the lesser of entrepreneur user messages and expert user messages (e.g., to measure the essential volume of interaction).

As n increases, the likelihood of “significant involvement” should increase non-linearly. Globally, there may be a threshold n_t after which the likelihood of “substantial investment” becomes greater than a threshold percentage such as fifty percent. Globally matching engine 118 can assess the probability.

“X” may be an adjustable parameter in the equation. The larger “X” is set, the greater preference/weight is placed on long interactions. This may correspond to meaning that a substantial involvement is much more likely to occur after longer interactions. Even if frequency is low, the information learned from long interactions is favored by future entrepreneur users. If “X” is set to “X”<1, matching engine 118 may assume that substantial involvement can occur at much shorter interactions. The information learned about a person's involvement chance or interaction with the expert user may be marginally decreasing.

Matching engine 118 may adjust these values based on the value that is to be maximized from communications and connections. For example, the system may observe the frequencies of substantial involvement conditioned on the number of exchanges occurring in each session. If f only becomes meaningful after a large n, then X may be set to be very big in order to highlight long interactions. If f is meaningful pretty much from the start, then matching engine 118 may determine that a corresponding time or value of long interactions may be highlighted.

Matching engine 118 may invert a determination of associating expert users feedback with an entrepreneur user. For example, matching engine 118 may determine a likelihood that a particular entrepreneur user that receives the expert user's feedback to entrepreneur users will find the feedback useful (e.g., by selecting the right entrepreneur user). In another example, matching engine 118 may determine a likelihood that the particular expert user's feedback to entrepreneur users will be beneficial to the entrepreneur user (e.g., by selecting the right feedback).

Calendaring engine 120 is configured to identify one or more timeslots of the expert user that are available to an entrepreneur user. The one or more timeslots may be identified from a first calendar of the expert user as time that is unscheduled for the expert user. In other examples, the one or more timeslots may be received from the expert user and updated in an application to provide the availability of the expert user.

The one or more timeslots may be associated with different values. For example, a timeslot may be associated with a default value of time (e.g., five-minutes) of the expert user. The entrepreneur user may purchase the timeslot to receive communication access to the expert user for the default value of time.

The one or more timeslots may be associated with a physical, face-to-face interaction that occurs at a particular time or a virtual interaction between the entrepreneur user and the expert user.

Machine learning engine 122 is configured to determine a likelihood of success between the entrepreneur user and the expert user. For example, the system may match the search criteria of the entrepreneur user with one or more characteristics of the expert user based on the likelihood that the expert user will invite the entrepreneur user for additional communication, feedback, or other future action (e.g., invitation to provide a formal pitch to the expert user, in-person meeting, funding discussion, future partnership, etc.).

The machine learning model may generate a likelihood of success score between the expert user and the entrepreneur user based on characteristics of the expert user, a product or service of the entrepreneur user, or other parameters associated with the entrepreneur user and the expert user. This likelihood of success score can be generated simultaneously with additional likelihood of success scores for a plurality of additional expert users to provide a comparison between all expert users. The model may also note a target value for the entrepreneur user to illustrate the user's investment goals. For example, the entrepreneur user may be seeking one million dollars in investments, so the target value could be one million. The expert user may be selected if the expert user can provide an investment that meets the target value. Using the example described above, the expert user may be willing to invest up to 1.5 million dollars, so the expert user would be selected to fulfill the target value. In other embodiments, where the expert user does not meet the target value, the model will review additional expert users such that the aggregate total of all users meets or exceeds the target value. Using the first example, if the expert user can only provide $500,000, then a second expert user may be selected. If that second expert user can provide $600,000, then the aggregate of the two expert users exceeds the target value, warranting a timeslot reservation for both expert users. The system may then make a timeslot reservation for both expert users. The model may also aim to minimize the number of expert users, such that a pitch can be sent to less expert users.

When the likelihood of success score exceeds a success threshold value, an available timeslot of the expert user may be determined (e.g., via calendaring engine 120) and reserved for the entrepreneur user. This timeslot may also be reserved if the likelihood of success score exceeds that of the additional expert users. In some examples, the timeslot of the expert user may be reserved upon initiating a transaction for the entrepreneur user associated with the timeslot of the expert user. The machine learning model may also note the reserved timeslot to automatically generate a virtual introduction. This may be accomplished by sending a pitch file, generating a virtual video meeting, or initiating a phone call between the entrepreneur user and the expert user.

Machine learning engine 122 may select a plurality of features from the pitch file of the entrepreneur user. The features may be determined using natural language processing, parsing in text analysis, an affinity matrix (e.g. associating what information is related and how similar the users are, etc.).

Feedback engine 124 is configured to provide feedback to an entrepreneur user. The feedback may comprise that the expert user suggests that the entrepreneur should perform, mentoring, introductions to other expert users, or funding for the product or service associated with the entrepreneur user. In some examples, the feedback is provided in the format of a feedback file generated by expert user device 130. The connection and communication system may include an interface for user access. The interface may include images of one or more expert users that are available to communicate with by one or more entrepreneur users via connection and communication system 110 illustrated in FIG. 1.

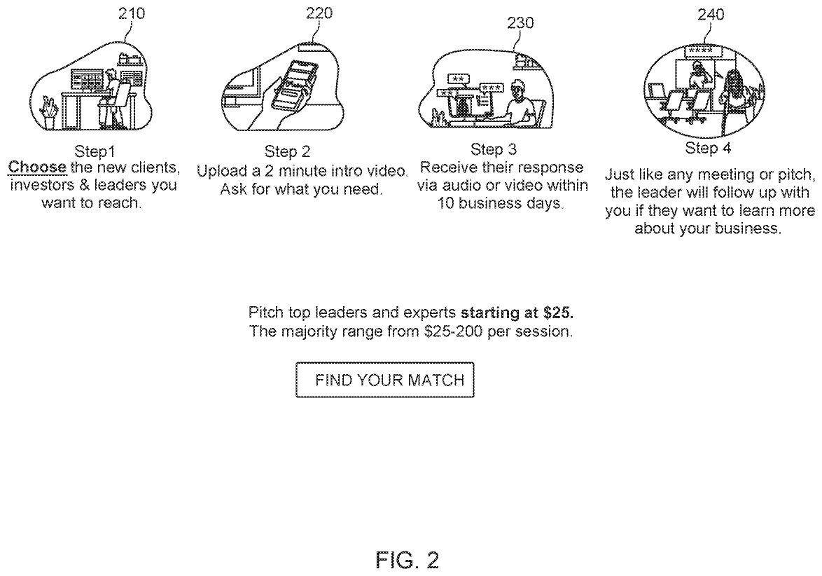

FIG. 2 is an illustrative process for an entrepreneur user device, in accordance with the embodiments disclosed herein. The process may be embodied in machine-readable instructions accessible by entrepreneur user devices 132 and connection and communication system 110 via network 140 illustrated in FIG. 1.

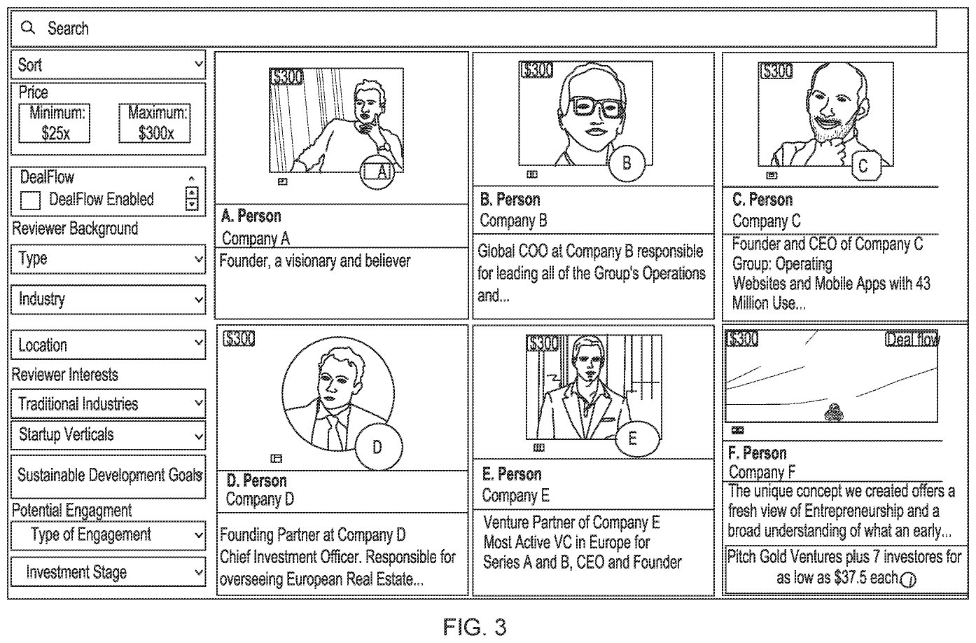

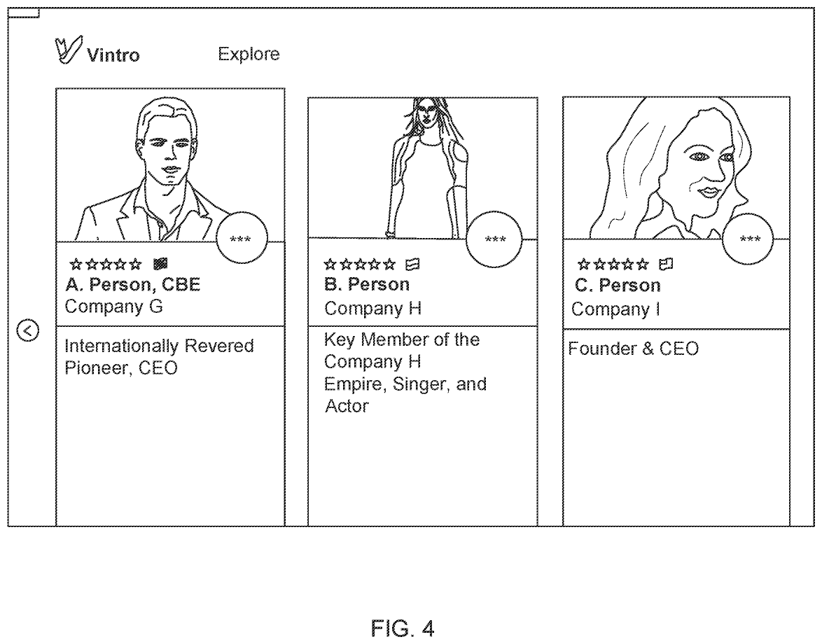

At 210, the process may comprise choosing an expert user (e.g., new client, investor, leader, etc.) from the plurality of expert users, as illustrated with FIGS. 3-4. For example, entrepreneur user device 132 may access a search tool provided by connection and communication system 110 via network 140 and search for an expert user based on their characteristics (e.g., company, expertise, etc.). The search tool may return a filtered list of expert users based on the search criteria provided by entrepreneur user. In some embodiments, this list may be sorted according to each expert user's likelihood of success score.

In some examples, the ability to choose the expert user from the plurality of expert users may be provided at a cost. Entrepreneur user may transmit the cost of choosing the expert user to connection and communication system 110, where the value is transmitted from the entrepreneur user to the expert user upon a satisfactory completion of the communication between the users (e.g., transmitting a pitch file and receiving feedback, etc.).

At 220, the process may receive and store a pitch file from entrepreneur user device 132. For example, entrepreneur user device 132 may record a short introduction video (e.g., two minutes) that includes entrepreneur user explaining the product or service and asking the expert user for feedback. Connection and communication system 110 may provide the pitch file to a particular expert user.

At 230, the process may receive a feedback file from the expert user. For example, expert user device 130 may record audio or video feedback to the entrepreneur user in association with their product or service. The feedback file may be transmitted to the entrepreneur user device 132 within a timeframe (e.g., within 10 days).

At 240, the process may enable future communication between entrepreneur user and expert user. For example, the expert user may follow up with the entrepreneur user if additional information is re requested.

FIG. 3 is an illustrative search user interface, in accordance with the embodiments disclosed herein. In some embodiments, the entrepreneur user can filter a list including brief overviews of the expert user profiles. The profiles can be filtered by various characteristics, including but not limited to expertise or profile characteristics of the expert user, any companies the expert user represents, price for establishing a communication session, industry, type of company, location, development goals, and other personal characteristics of the expert user. Overviews of expert profiles can contain various forms of general information, including name, company, position, sales offerings, photos, and other characteristics as described herein.

FIG. 4 is an illustrative search user interface, in accordance with the embodiments disclosed herein. In some embodiments, one or more expert profiles may be provided to an entrepreneur user, which may choose to focus on one expert profile. Each overview can include characteristics as described herein, but can also include other characteristics such as a rating or relevant country. This overview may be provided when the system suggests various expert users to the entrepreneur user before the entrepreneur user initiates any search or filtering. This suggestion list can be formed in accordance with the matching algorithms described herein.

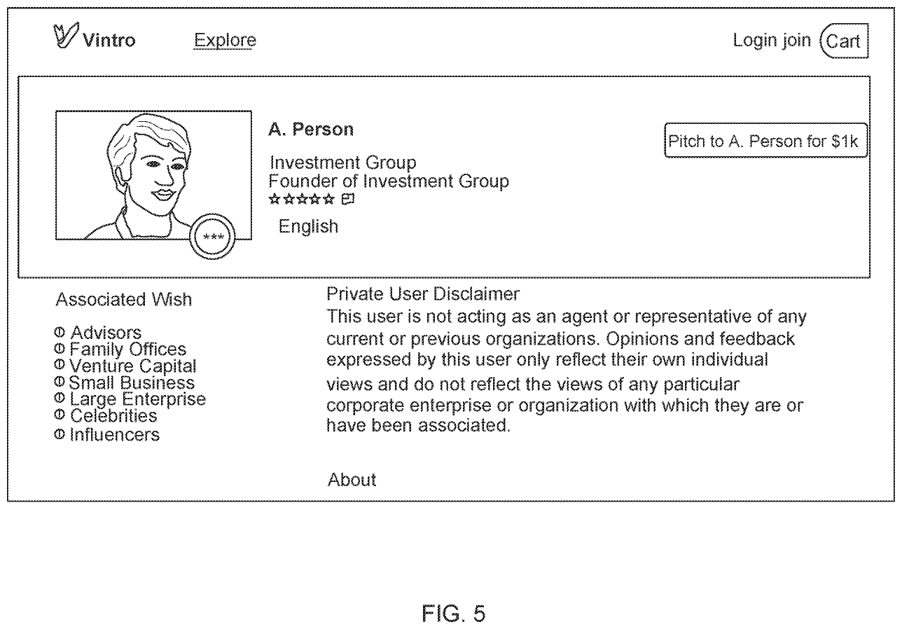

FIG. 5 is an illustrative expert user profile, in accordance with the embodiments disclosed herein. The expert user profile may provide the characteristics of the expert user, including a name, profile image, job title, company, expertise, price per session, expertise description, and other relevant information.

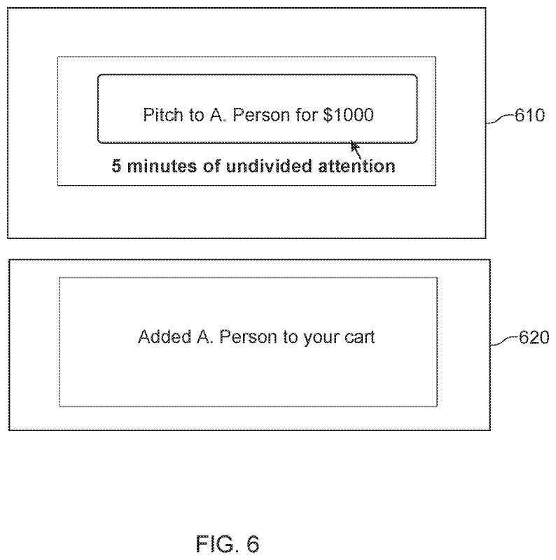

FIG. 6 is an illustrative communication and connection interface tool, in accordance with the embodiments disclosed herein. The communication and connection interface tool 610 may receive an interaction from the entrepreneur user via entrepreneur user device 132 and identify the expert user in a digital cart 620 associated with the entrepreneur user. The communication and connection interface tool 610 and digital cart 620 may be accessible via a software application installed with entrepreneur user device 132 or via a browser application at entrepreneur user device 132.

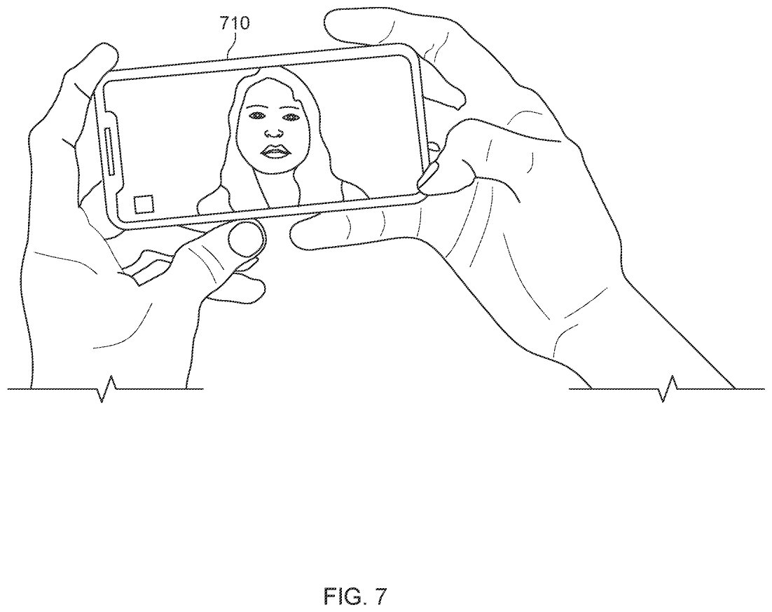

FIG. 7 is an illustrative entrepreneur user device, in accordance with the embodiments disclosed herein. Entrepreneur user device 132 may record entrepreneur user using a camera, microphone, or other sensors installed with entrepreneur user device 132 to generate the pitch file 710. As described herein, the pitch file may describe a product or service provided by the entrepreneur user may request feedback from the expert user for a particular aspect of the product or service.

The feedback provided to entrepreneur users may vary in form in accordance with one or more of the embodiments disclosed herein. For example, the feedback may what the expert user liked about the content of the pitch file, what issues they see, and what next steps they recommend. The connection and communication system 110 may generate an opportunity to develop a relationship with the expert user. In some examples, the expert user may open a direct communication with the entrepreneur user to learn more about the product or service associated with the entrepreneur user (e.g., inside or outside of connection and communication system 110). The direct communication may include initiating a new investment or funding, a new client for the product or service provided by the entrepreneur user, an introduction or referral to other entities, advice, mentorship, a face-to-face meeting, or other information. Connection and communication system 110 may provide many technical advantages over other systems. This may include a fast and efficient communication process between one or more entrepreneur users and one or more expert users, less expense, guaranteed time and attention with the expert user, and an improved matching process between the entrepreneur user and expert user.

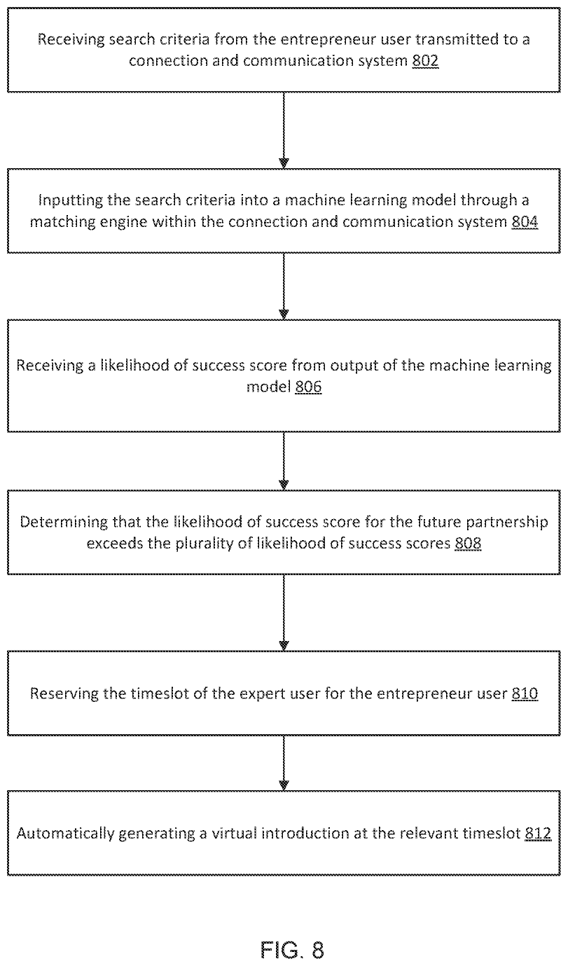

FIG. 8 is an illustrative process for generating a virtual introduction, in accordance with the embodiments disclosed herein. The process illustrated herein may be implemented by connection and communication system 110 described in FIG. 1 or any of the embodiments illustrated herein.

At block 802, connection and communication system 110 as illustrated in FIG. 1 receives search criteria from the entrepreneur user. This search criteria can include but is not limited to: target investment value, industry, name, company, or other identifying characteristics.

At block 804, connection and communication system 110 may input the search criteria into a machine learning model through matching engine 118. This machine learning model may operate in accordance with the processes described herein.

At block 806, connection and communication system 110 may receive a likelihood of success score from output of the machine learning model. The likelihood of success score can predict a future partnership between the expert user and the entrepreneur user in accordance with the matching algorithms provided in matching engine 118 illustrated in FIG. 1. The system can simultaneously determine a plurality of likelihood of success scores for partnerships between the entrepreneur user and each of the plurality of expert users. The plurality of likelihood of success scores provides a comparison that enables the system to select an optimal expert user for the entrepreneur user such that a partnership is likely to be successful.

At block 808, connection and communication system 110 may determine whether the score exceeds the plurality of likelihood of success scores. As mentioned herein, by determining a plurality of likelihood of success scores, the system is able to select the expert user that provides the highest likelihood of success score.

At block 810, connection and communication system 110 can reserve a timeslot of the selected expert user. This time slot may be selected from a plurality of available times provided by expert user, or through a review of available time slots as determined by the timeslots reserved to other entrepreneur users.

At block 810, connection and communication system 110 generates a virtual introduction at the relevant timeslot. For example, the virtual introduction may occur through various forms of media, such as a pitch file, video call, or other direct communication method. The system can open direct communication session between the entrepreneur user and the expert user on or before the relevant timeslot in preparation for the virtual introduction.

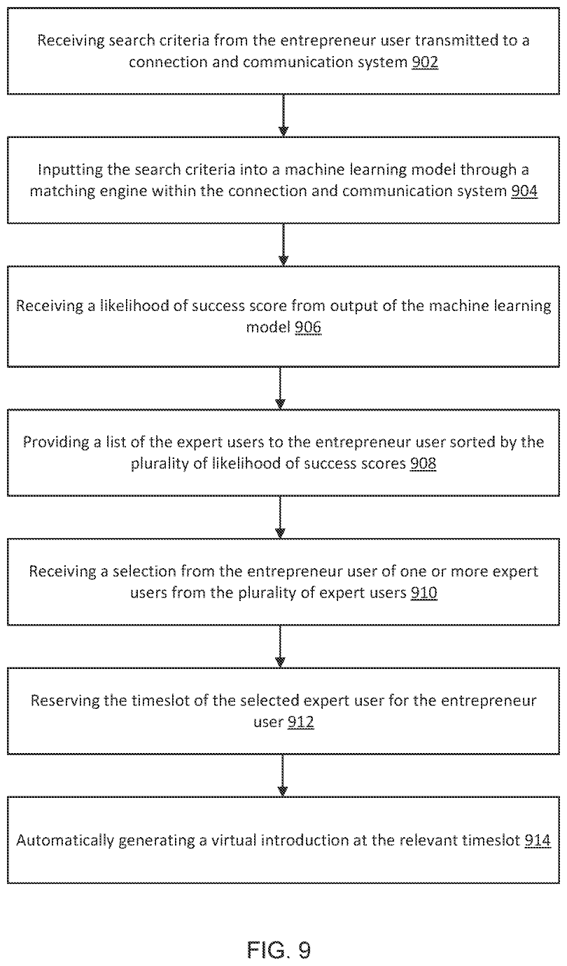

FIG. 9 is an additional illustrative process for generating a virtual introduction, in accordance with the embodiments disclosed herein. The process illustrated herein may be implemented by connection and communication system 110 described in FIG. 1 or any of the embodiments illustrated herein.

At block 902, connection and communication system 110 may receive search criteria from the entrepreneur user. As described herein, the search criteria can include but is not limited to: target investment value, industry, name, company, or other identifying characteristics.

At block 904, connection and communication system 110 may input the search criteria into a machine learning model through matching engine 118. As described herein, this machine learning model may operate in accordance with the processes described herein.

At block 906, connection and communication system 110 may receive a likelihood of success score from output of the machine learning model. As described herein, the likelihood of success score predicts a future partnership between the expert user and the entrepreneur user in accordance with the matching algorithms provided in matching engine 118. Connection and communication system 110 can simultaneously determine a plurality of likelihood of success scores for partnerships between the entrepreneur user and each of the plurality of expert users.

At block 908, connection and communication system 110 may provide a list of expert users to the entrepreneur users sorted by the plurality of likelihood of success scores. This may be listed from highest score to lowest score, or may be filtered according to particular characteristics provided by the entrepreneur user. The list of expert users may contain overviews of various profiles as illustrated in FIGS. 3-4, or may include other types of information on the expert users.

At block 910, connection and communication system 110 may receive a selection by the entrepreneur user of one or more expert users from the plurality of expert users displayed to the entrepreneur user. The entrepreneur user may apply further filtering criteria prior to selecting a profile.

In some examples and illustrated in FIG. 5, the entrepreneur user may review an individual expert profile in its entirety prior to selecting the expert user. This may be accomplished through an actuation mechanism on the expert user profile that allows a user to reserve timeslot or requests payment information such that the entrepreneur user can submit payment to reserve a timeslot.

At block 912, connection and communication system 110 can reserve a timeslot of the selected expert user. As described herein, this timeslot may be selected from a plurality of available times provided by expert user, or through a review of available timeslots as determined by the timeslots reserved to other entrepreneur users.

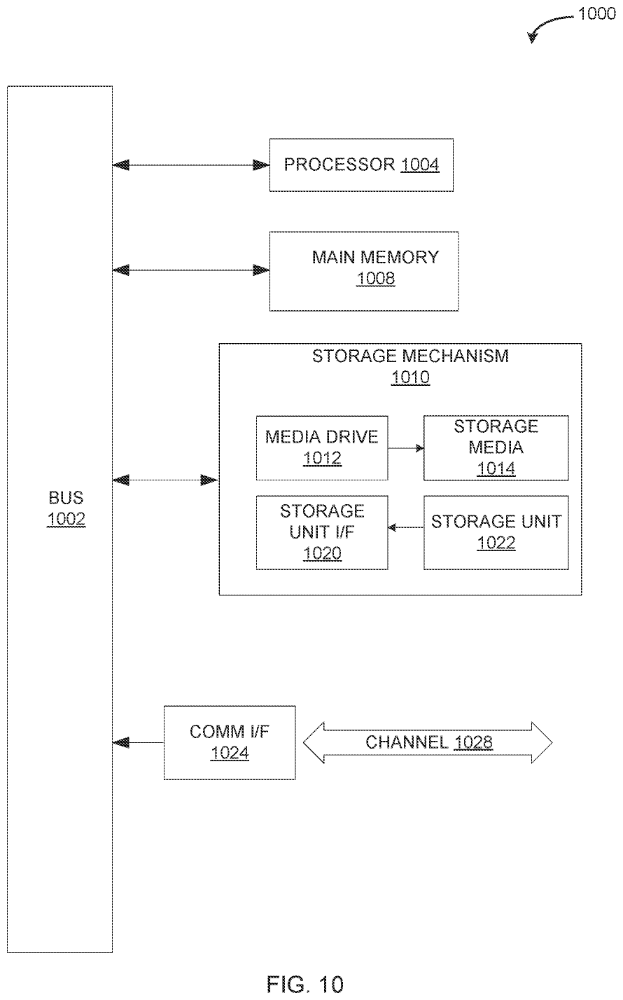

At block 914, connection and communication system 110 may generate a virtual introduction at the relevant timeslot. As described herein, this virtual introduction may occur through various forms of media, such as a pitch file, video call, or other direct communication method. The system can open direct communication between the entrepreneur user and the expert user on or before the relevant timeslot in preparation for the virtual introduction.

Where components, logical circuits, or engines of the technology are implemented in whole or in part using software, in one embodiment, these software elements can be implemented to operate with a computing or logical circuit capable of carrying out the functionality described with respect thereto. One such example logical circuit is shown in FIG. 10. Various embodiments are described in terms of this example logical circuit 1000. After reading this description, it will become apparent to a person skilled in the relevant art how to implement the technology using other logical circuits or architectures.

Referring now to FIG. 10, computing system 1000 may represent, for example, computing or processing capabilities found within desktop, laptop, and notebook computers; hand-held computing devices (PDA's, smart phones, cell phones, palmtops, etc.); mainframes, supercomputers, workstations, or servers; or any other type of special-purpose or general-purpose computing devices as may be desirable or appropriate for a given application or environment. Logical circuit 1000 might also represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computing system 1000 might include, for example, one or more processors, controllers, control engines, or other processing devices, such as a processor 1004. Processor 1004 might be implemented using a general-purpose or special-purpose processing engine such as, for example, a microprocessor, controller, or other control logic. In the illustrated example, processor 1004 is connected to a bus 1002, although any communication medium can be used to facilitate interaction with other components of logical circuit 1000 or to communicate externally.

Computing system 1000 might also include one or more memory engines, simply referred to herein as main memory 1008. For example, preferably random-access memory (RAM) or other dynamic memory, might be used for storing information and instructions to be executed by processor 1004. Main memory 1008 might also be used for storing temporary variables or other intermediate information during execution of instructions to be executed by processor 1004. Logical circuit 1000 might likewise include a read only memory (“ROM”) or other static storage device coupled to bus 1002 for storing static information and instructions for processor 1004.

The computing system 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a floppy disk drive, a magnetic tape drive, an optical disk drive, a CD or DVD drive (R or RW), or other removable or fixed media drive might be provided. Accordingly, storage media 1014 might include, for example, a hard disk, a floppy disk, magnetic tape, cartridge, optical disk, a CD or DVD, or other fixed or removable medium that is read by, written to, or accessed by media drive 1012. As these examples illustrate, the storage media 1014 can include a computer usable storage medium having stored therein computer software or data.

In alternative embodiments, information storage mechanism 1240 might include other similar instrumentalities for allowing computer programs or other instructions or data to be loaded into logical circuit 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory engine) and memory slot, a PCMCIA slot and card, and other fixed or removable storage units 1022 and interfaces 1020 that allow software and data to be transferred from the storage unit 1022 to logical circuit 1000.

Logical circuit 1000 might also include a communications interface 1024. Communications interface 1024 might be used to allow software and data to be transferred between logical circuit 1000 and external devices. Examples of communications interface 1024 might include a modem or soft modem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1024 might typically be carried on signals, which can be electronic, electromagnetic (which includes optical) or other signals capable of being exchanged by a given communications interface 1024. These signals might be provided to communications interface 1024 via a channel 1028. This channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1008, storage unit 1020, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the logical circuit 1000 to perform features or functions of the disclosed technology as discussed herein.

Although FIG. 10 depicts a computer network, it is understood that the disclosure is not limited to operation with a computer network, but rather, the disclosure may be practiced in any suitable electronic device. Accordingly, the computer network depicted in FIG. 10 is for illustrative purposes only and thus is not meant to limit the disclosure in any respect.

While various embodiments of the disclosed technology have been described herein, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described herein in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “engine” does not imply that the components or functionality described or claimed as part of the engine are all configured in a common package. Indeed, any or all of the various components of an engine, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for generating a virtual introduction between an entrepreneur user and a plurality of expert users, the method comprising:
receiving search criteria from the entrepreneur user transmitted to a connection and communication system;
inputting the search criteria into a machine learning model through a matching engine within the connection and communication system;
receiving a likelihood of success score from output of the machine learning model, wherein the likelihood of success score predicts a future partnership between the expert user and the entrepreneur user, while simultaneously determining a plurality of likelihood of success scores for partnerships between the entrepreneur user and each of the plurality of expert users;
determining that the likelihood of success score for the future partnership exceeds the plurality of likelihood of success scores;
reserving the timeslot of the expert user for the entrepreneur user; and
automatically generating a virtual introduction at the relevant timeslot.

2. The method of claim 1, further comprising receiving a pitch file from the entrepreneur user and transmitting the video file to the expert user, wherein the pitch file comprises at least one of an audio file, visual (A/V) file, and a data stream.

3. The method of claim 1, further comprising receiving a feedback file from the expert user and transmitting the input to the entrepreneur user, wherein the feedback file comprises at least one of a video file and an audio file.

4. The method of claim 1, further comprising receiving electronic payment information from the entrepreneur user and initiating a transaction associated with the timeslot of the expert user.

5. The method of claim 1, further comprising determining a confidence value associated with the expert user, wherein a higher confidence value represents an expert user that may provide a higher amount of funding or a stronger recommendation.

6. The method of claim 5, further comprising receiving information from the entrepreneur that the expert user provided feedback and adjusting the confidence value.

7. The method of claim 1, further comprising:
receiving a target value from the entrepreneur user, wherein the target value represents the total sum that the entrepreneur user wants to raise;
determining that the expert user's maximum investment is less than the target value;
selecting one or more additional expert users to reserve a timeslot until all expert users have an aggregate maximum investment equal to or more than the target value; and
reserving a timeslot for all expert users.

8. The method of claim 7, wherein the one or more additional expert users are selected to minimize the total number of expert users.

9. A method for generating a virtual introduction between an entrepreneur user and a plurality of expert users, the method comprising:
receiving search criteria from the entrepreneur user transmitted to a connection and communication system;
inputting the search criteria into a machine learning model through a matching engine within the connection and communication system;
receiving a likelihood of success score from output of the machine learning model, wherein the likelihood of success score predicts a future partnership between the expert user and the entrepreneur user, while simultaneously determining a plurality of likelihood of success scores for partnerships between the entrepreneur user and each of the plurality of expert users;
providing a list of the expert users to the entrepreneur user sorted by the plurality of likelihood of success scores;
receiving a selection from the entrepreneur user of one or more expert users from the plurality of expert users;
reserving the timeslot of the selected expert user for the entrepreneur user; and
automatically generating a virtual introduction at the relevant timeslot.

10. The method of claim 9, wherein the list of expert users comprises a plurality of expert profiles, wherein each expert profile is associated with an expert user from the plurality of expert users.

11. The method of claim 9, wherein the selection of one or more expert users involves selecting an expert profile from the plurality of expert files.

12. The method of claim 9, wherein each expert profile comprises a cost to reserve a timeslot.

13. The method of claim 9, further comprising filtering the list of expert users based on one or more classifications associated with each expert user.

14. The method of claim 13, wherein the classifications are determined by metadata associated with at least one of an expert profile and a pitch file received from the entrepreneur user.

15. A system for generating a virtual introduction between an entrepreneur user and a plurality of expert users comprising:
a hardware processor; and
a non-transitory machine readable storage medium encoded with instructions executable by the hardware processor to:
receive search criteria from the entrepreneur user transmitted to a connection and communication system;
input the search criteria into a machine learning model through a matching engine within the connection and communication system;
receive a likelihood of success score from output of the machine learning model, wherein the likelihood of success score predicts a future partnership between the expert user and the entrepreneur user, while simultaneously determining a plurality of likelihood of success scores for partnerships between the entrepreneur user and each of the plurality of expert users;
determine that the likelihood of success score for the future partnership exceeds the plurality of likelihood of success scores;
reserve the timeslot of the expert user for the entrepreneur user; and
automatically generate a virtual introduction at the relevant timeslot.

16. The system of claim 15, further comprising a video camera, wherein the instructions executable by the hardware processor further causes the hardware processor to generate a pitch file for the entrepreneur user with the video camera.

17. The system of claim 15, wherein the instructions executable by the hardware processor further causes the hardware processor to generate a pitch file,
wherein the pitch file comprises a data stream, and
wherein the instructions executable by the hardware processor further causes the hardware processor to establish a real-time connection between the entrepreneur user and the expert user.

18. The system of claim 15, wherein the instructions executable by the hardware processor further causes the hardware processor to receive a pitch file from the entrepreneur user and transmitting the video file to the expert user, and wherein the pitch file comprises at least one of an audio file, visual (A/V) file, and a data stream.

19. The system of claim 15, wherein the instructions executable by the hardware processor further causes the hardware processor to receive a feedback file from the expert user and transmitting the input to the entrepreneur user, wherein the feedback file comprises at least one of a video file and an audio file.

20. The system of claim 15, wherein the instructions executable by the hardware processor further causes the hardware processor to receive electronic payment information from the entrepreneur user and initiating a transaction associated with the timeslot of the expert user.
